(19) United States
(12) Patent Application Publication
(10) Pub. No.: US 2012/0300065 A1
(43) Pub. Date: Nov. 29, 2012

(54) OPTICAL DEVICE FOR MEASURING AND IDENTIFYING CYLINDRICAL SURFACES BY DEFLECTOMETRY APPLIED TO BALLISTIC IDENTIFICATION

(75) Inventors: Daniel Pedro Willemann, Florianopolis SC (BR); Armando Albertazzi Gonçalves Junior, Florianopolis SC (BR); Celso Luiz Nickel Veiga, Florianopolis SC (BR); Analucia Vieira Fantin Pezzotta, Florianopolis SC (BR); Yara Lemr, Florianopolis SC (BR)

(73) Assignee: PHOTONITA LTDA, Florianopolis - SC (BR)

(21) Appl. No.: 13/575,724

(22) PCT Filed: Jan. 25, 2011
(86) PCT No.: PCT/BR2011/000028

§ 371 Date: Jul. 27, 2012

(30) Foreign Application Priority Data
Jan. 27, 2010 (BR) PI 1000301

(51) Int. Cl. H04N 7/18

(52) U.S. Cl. 348/136; 348/142; 348/E07.085

(57) ABSTRACT

Optical Device for Measuring and Identifying Cylindrical Surfaces by Means of Deflectometry, Applied for Ballistic Identification” describes an optical device that uses a configuration of the technique known as “deflectometry”, said device is built with a conical mirror for identifying and measuring fully or partly reflective cylindrical surfaces, and its configuration is particularly applied to ballistic identification.

Description of an optical device that applies a configuration of technique known as “deflectometry”. This device is built with a conical mirror for identifying and measuring fully or partly reflective cylindrical surfaces, and its configuration is particularly applied to ballistic identification.

The deflectometria an optical technique is sensitive to changes in topography and unevenness of a surface. Allows you to identify and measure the geometry of parts from the distortions observed in a sequence of images reflected on the surface of interest. The deflectometria is a technique known in the international literature as “fringe reflection” or “deflectometry,” now being disseminated and used in commercial systems for measurement and inspection of flat surfaces. Recently, equipment intended other applications have explored the same measuring principle for industrial applications of high precision because of their ruggedness and capacity to reveal more detail. The product QUALISURF, VISUOL the French company, and product SURFCHECK, the German company VIALUX are examples of commercial systems that use deflectometria in its conception. Both systems perform in factory environment, the inspection of surfaces in the metal-mechanical, in fractions of a second.

Measurement by deflectometry is quite responsive to local inclinations and curvatures of the measured surface, as consequences of relief variation of the surface. An analogy could be done by viewing the reflection of a geometric, regular structure on a car door. In this case, there occurs a distortion of the structure, caused by curvature of the car body. Applied with high optical magnification, such process evidences the imperfections of reflecting surface, which are collections of little, located curvatures and inclinations.

The simplest building configuration of an optical device that could be used on deflectometry is compounded by a projection screen or a luminous surface and a video camera. A pattern of structured light, commonly with sinusoidal profile, is projected on the screen. The video camera captures the image from measured surface, and it explores the structured pattern reflected by this surface. The camera captures not a single image, but a sequence of images, which are digitally processed, generating a map with information related to inclinations and curvatures that are present on the part surface. Measurement quantification is done relative to a reference that, for the case of shapes measurement, is generally a plain surface.

The digital image processing is performed from a “phase shift” that is to change slightly, and in a controlled manner, the phase relationship between successive images projected on the screen. The phase increment between the images must be well defined, usually 90°. By this method, instead of acquiring a single image, multiple images are acquired, usually four or five, which are combined to calculate the phase map. The map of phase difference represents the difference between the reflections from two surfaces, the first as a reference and the second from the part to measure. The phase difference map contains information from the field of inclinations and curvatures.

The inner surface of most firearms barrels contains a set of helical grooves with a dual purpose. The first is to give to the bullet a rotary motion around the axis of the barrel, resulting in a more rectilinear, firm and well defined trajectory. The second purpose is to print a “signature” on the bullet. The shape of grooves and rifling of the barrels of each gun are different and this makes marks on the bullet that are unique. The comparison between the micro-grooves (“signatures”) in the cylindrical surface of the shot bullets and the spiral grooves inside the barrel of the firearm is the basis for ballistic identification. There are some commercial systems that perform this operation. Documents US 2005/0244080 A1, 3D Bullet and Cartridge Case Analysis, of 3 Nov. 2005; U.S. Pat. No. 5,390,108A, Computer Automated Bullet Analysis Apparatus, of 14 Feb. 1995 are patent documents that show measurement principle of systems already commercially available. In all cases, you can only measure a portion of the cylindrical surface at a time. It is necessary to rotate the bullet of angular increments well defined and composing multiple views obtained from the lateral cylindrical surface so that the measurement is performed at 360°. Moreover, none of these systems uses deflectometry on bullet measurement process.

Currently, there is no equipment for ballistic identification that uses methods based on the calculation of the phase map, which makes the image very little dependent on the lighting condition, resulting in much sharper images and without requiring the operator to adjust the lighting condition.

This report describes a device whose new feature is the application of the technique known as “deflectometry” associated with an optical arrangement containing a conical mirror. The optical device is designed to measure the cylindrical surface of reflective parts. The building configuration of the equipment presents a solution dedicated to the ballistic identification. The device described in this report is comprised of two low-resolution cameras for aligning the cylindrical part to be measured; two displacement tables for transversal alignment of the projectile, two tables of rotation for angular alignment of the projectile, a conical mirror for flattening the image, a high-resolution video camera, with objective lens, a multimedia projector, a half-mirror and a projection screen.

Using the conical mirror in this configuration it transforms the image of the cylindrical surface of the part in a flat annular image. The conical mirror allows to measure cylindrical parts from a single position, simplifies the optical configuration, greatly improves the performance and reduces the measurement time.

This optical configuration is very effective when used in ballistic identification, where measuring the micro-grooves present on the lateral cylindrical surface of bullets is necessary to recognize those shot by the same weapon The following description and the associated pictures, for example, will allow a better understanding of the optical device, object of this report.

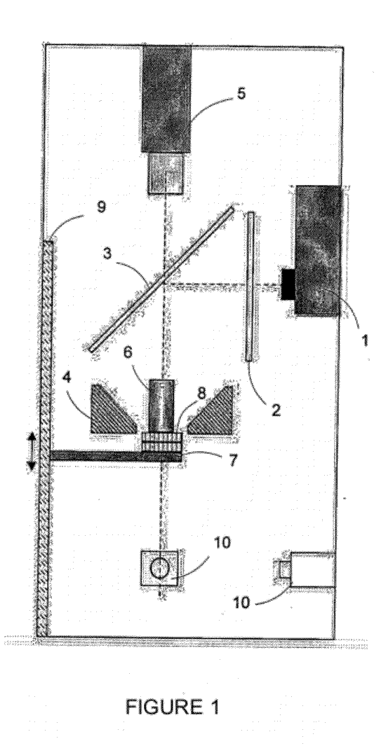

FIG. 1 shows the configuration of the optical device for measuring cylindrical parts, with the projectile (6) within the conical mirror (4), here represented in a crop, ready to be measured.

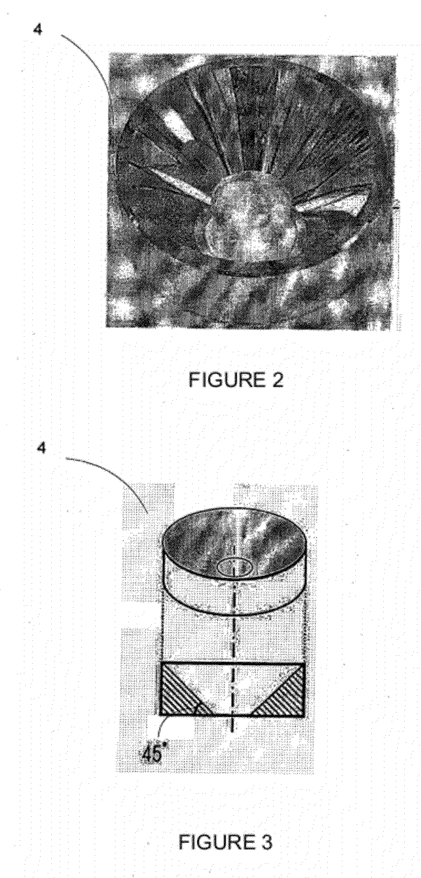

FIG. 2 shows a representative image of the conical mirror (4), evidencing that the reflecting surface is the internal surface.

FIG. 3 shows a perspective view and a cut of the conical mirror (4) used here.

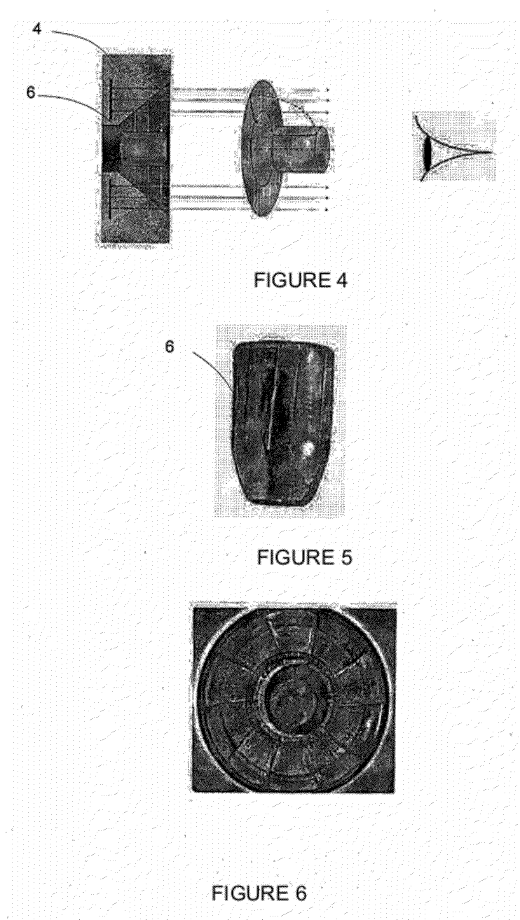

FIG. 4 shows the path of the beams reflected by the conical mirror (4) and the formation of the flattened image of a cylinder placed inside. The cylindrical surface is transformed into a flat disk.

FIG. 5 is a representative image of a projectile (6) used in firearms; it shows the superficial grooves made by the firearm.

FIG. 6 shows an image captured by the high-resolution camera (5). It is the front view of a projectile (6) positioned within the conical mirror (4) and reflected on its inner surface.

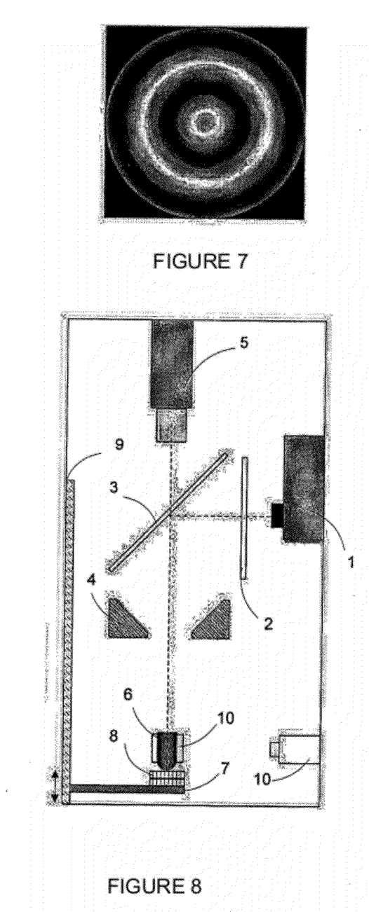

FIG. 7 shows the concentric fringe pattern projected on the screen of the system to make the alignment of the standard cylinder.

FIG. 8 shows the projectile (6) to be measured, when aligned with the axis of the mirror, positioned in front of one of the video cameras (10) arranged at 90°.

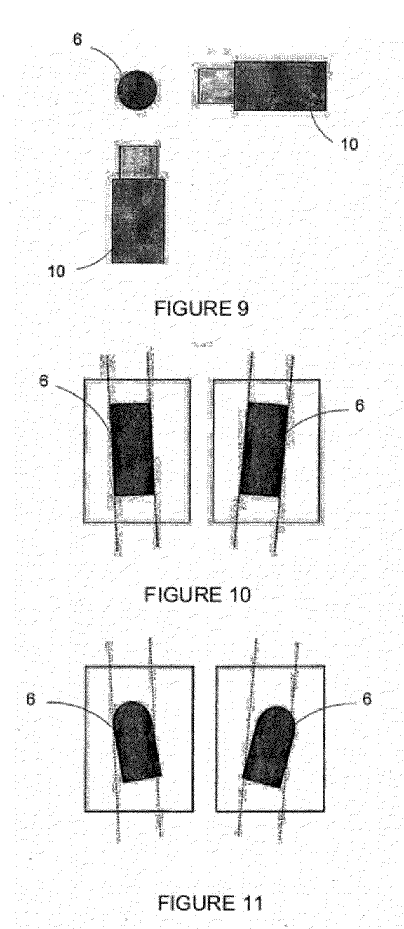

FIG. 9 shows a top view of the arrangement of two video cameras (10), perpendicular to each other, which are used in the alignment.

FIG. 10 shows the dotted lines defining the axis of the conical mirror (4) in each of the images captured.

FIG. 11 shows the images of a projectile (6) captured by two video cameras (10) arranged at 90°.

About the presented figures, the optical device for measuring cylindrical surfaces, subject of this report, is basically represented by FIG. 1. It is comprised of a multimedia projector (1), a projection screen (2) and a half-mirror (3). On one side of half-mirror (3), a conical mirror (4) is placed aligned with the optical axis of the system and on the other side of the half-mirror (3) a high resolution camera (5) with an appropriate objective lens is placed also aligned with the optical axis. The projectile (6), or a standard cylinder or a cylindrical part to be measured, should be placed in the center of the conical mirror (4) and also should be coaxial with the optical axis, as shown in FIG. 1. The optical axis is represented in this figure by the vertical dashed line. It should be noted that the projectile (6) hereinafter identified, may be a cylindrical part, a standard cylinder or any other body with similar geometry, whose shape we want to measure, not characterizing the object of the present request. The device also includes a displacement table (7) and a rotation table (8) where the projectile (6) is supported and it is aligned. The displacement table (7) also moves vertically by means of a linear guide (9). The device also comprises two video cameras (10) placed below the conical mirror (4), arranged at 90° relative to each other and, simultaneously, perpendicular to the optical axis, which contains the center of the rotation table (8).

FIGS. 2 and 3 show the conical mirror (4) which is the essential distinguishing feature of the optical device for measuring cylindrical parts. This conical mirror (4), has a generatrix forming an angle of 45° with its base, as shown in FIG. 3. Also such generatrix makes an angle of 45° with the axis of the conical mirror. The function of the conical mirror (4) is to flatten the image of side cylindrical surface of the projectile (6) or a cylindrical piece. The flattened image is captured by the high-resolution camera (5), which is also a part of the optical device, and resembles a flat disc.

FIG. 4 representatively shows the path of the beams originally parallel to the optical axis when reflected by the conical mirror (4). When a light beam, parallel to the optical axis, touches the conical mirror (4), it is reflected at 90° and operates perpendicularly to the reflective surface of the projectile (6). The reflected beam returns traversing the same path in reverse. FIG. 5 shows in a representative way, a projectile (6) and FIG. 6 shows a flattened image of the projectile (6), obtained by its reflection in the conical mirror (4).

The sequence of a measurement performed by the optical device may be observed by the following description with the aid of FIG. 1. The multimedia projector (1) projects a radial pattern of fringes with sinusoidal profile on the screen (2). This pattern is also known as “radial fringes”. The “radial fringes” projected on the screen (2) are reflected by the half mirror (3), the conical mirror (4), the surface of the projectile (6) and again by the conical mirror (4). The high-resolution camera (5), placed on the opposite side of the half-mirror (3) and aligned with the optical axis of the system, captures the image of the conical mirror (4) and notices the fringe pattern that reflects through the cylindrical surface of the projectile (6) or cylindrical body. A possible variation of the optical arrangement is to simply swap the high-resolution camera (5) with the multimedia projector (1).

Applying the method of “phase shift”, a set of images with lagged fringes is projected sequentially on the screen (2). The high-resolution camera (5) noting the projectile (6) or a cylindrical part through the conical mirror (4), captures the reflections of those images on the cylindrical surface of the projectile and transfers them to a computer that performs the processing. The result is a map containing the phase information. The calculated phase is directly related to the slopes on the surface of the projectile (6). The major advantages of phase maps compared with direct images of the intensity of the surface, lie on the purity of the geometric data and on the fact that this information is very little dependent on the color and reflectivity of the surface.

To facilitate the interpretation of the resulting phase map, a measurement of the phase map of a reference surface is subtracted from the measurement of the phase map of the projectile (6) being analyzed. The reference measurement can be performed with a standard cylinder, or even with the surface of the conical mirror (4), and can be stored digitally on the computer of the system without the need to re-determine it for each new bullet measured. The phase map resulting from the subtraction contains information related to the difference between the angle of inclination of the normal vectors with the surface of the projectile (6), compared to the normal vector with the reference surface.

This configuration is excellent for applications in ballistic identification, since it allows viewing with high sensitivity and high resolution details of the micro-grooves on the side surface of a shot projectile (6). The ballistic identification is made by using techniques of digital correlation of images, comparing the images and information taken directly from the phase maps of two projectiles.

The measured projectiles must respect the same alignment conditions, otherwise the micro-grooves may be distorted and mask their true “identity”, the comparison leading to an erroneous result. All projectiles (6) to be measured are aligned with the axis of the conical mirror (4). The alignment of the part with the axis of the conical mirror (4) can be accomplished with the aid of a standard cylinder by means of two video cameras (10) and the set of micrometrical displacement tables (7) and rotation tables (8). The standard cylinder is placed on a set of displacement tables (7) and rotation tables (8), giving to the part to be measured four degrees of freedom. The standard cylinder is taken to the center of the conical mirror (4) with the aid of the linear guide (9). Two fringe patterns are used during the alignment: One pattern of radial fringes and the other pattern of concentric fringes, FIG. 7. The phase maps obtained from the measurement of the standard cylinder with different patterns of fringes allow to identify the direction and sense of translation and rotation that should be applied to tables (7 and 8) until the alignment is completed. The standard cylinder, or the projectile (6) to be measured is aligned with the axis when maps present concentric and symmetrical patterns. To complete the alignment procedure with the aid of the linear guide (9) the standard cylinder, or the projectile (6) is placed in front of two video cameras (10) arranged at 90° one over another. FIG. 1 shows the optical device with the projectile (6), or the standard cylinder, placed within the conical mirror (4), which represents the measurement point of the part. FIG. 8 shows the projectile (6) or the standard cylinder after finding the axis of the conical mirror (4), and placed in front of the video cameras (10) arranged at 90° one over another.

The two video cameras (10) capture images of the pattern and, using image processing, the lines that define the axis of the conical mirror (4) in the two images calculated. A backlight is used to facilitate the visualization of the contour of the projectile (6) or standard cylinder and enhance its processing. FIG. 9 shows the arrangement of the two video cameras (10) used in the alignment. FIG. 10 shows the lines defining the place of the axis of the conical mirror (4) in each of the images captured.

FIG. 11 shows the images of a projectile (6) captured by two video cameras (10). Before the measurement, the axis of the projectile (6) is indirectly aligned to the axis of the conical mirror (4) through the lines previously determined with the projectile (6), or the default cylinder. After alignment, the projectile (6) is taken to the center of the conical mirror (4) by the linear guide (9) and the measurement is performed.

1. “Optical Device for Measuring and Identifying Cylindrical Surfaces by Means of Deflectometry, Applied for Ballistic Identification” describes the optical device that uses a technique known as “deflectometry”, said device is comprised of a multimedia projector (1), a projection screen (2), placed in front of the projector and a half-mirror (3) tilted, placed in front of said screen (2) also comprises a high-resolution camera (5) placed on one side of said half-mirror (3) and a displacement table (7) placed on the opposite side of the half-mirror (3) and attached on its outer end to a linear guide (9) allowing said displacement table (7) to perform translation movement and move vertically; a rotating table (8) is placed at the other end of the displacement table (7) where the projectile (6) or a standard cylinder or a cylindrical part to be measured is placed and aligned with the optical axis by means of two video cameras (10) arranged at 90° relative to each other and, simultaneously, perpendicular to the optical axis and placed at the end of opposite side of the high-resolution camera (5), said device has a conical mirror (4) placed on one side of half-mirror (3), this being the side opposite to the side where the high-resolution camera (5) is placed, and said conical mirror has an aligned axis with the optical axis of the device, and has a generatrix forming an angle of 45° with the axis of the conical mirror.

2. “Optical Device for Measuring and Identifying Cylindrical Surfaces by Means of Deflectometry, Applied for Ballistic Identification” describes the method to perform the measurement using said optical device, comprising the following steps:
a. Measuring a reference surface using a standard cylinder, or the surface of the conical mirror (4);
b. Transforming the said reference measurement in reference phase maps and digitally storing them in the computer of the system;
c. Aligning the cylinder, or projectile (6) to be measured using the video cameras (10), with the axis of the conical mirror (4), and placing in the center of said conical mirror (4);
d. the multimedia projector (1) projects a radial pattern of fringes, the “radial fringes”, with sinusoidal profile on the screen (2);
e. The “radial fringes” projected on the screen (2) are then reflected by the half mirror (3), the conical mirror (4), the surface of the projectile (6) and again by the conical mirror (4).
f. The high-resolution camera (5) captures the image of the conical mirror (4) and evidences the fringe pattern that reflects through the cylindrical surface of the projectile (6) or cylindrical body;
g. said high-resolution camera (5) captures those images, creating a phase map, and transfers it to the computer of the system;
h. the measuring of the phase map of the reference surface is subtracted from the measurement of the phase map of the projectile (6) being analyzed, generating a resulting phase map that contains information related to the difference between the angle of inclination of the normal vectors with the surface of the projectile (6), and the normal vector with the reference surface.
i. Using the resulting phase map in ballistic identification.
